(19) United States
(12) Patent Application Publication
(10) Pub. No.: US 2007/0248803 A1
(43) Pub. Date: Oct. 25, 2007

(54) Film Containing Transparent Metal Oxide, Method for the Production Thereof, and Thereof

(76) Inventors: Holger Kliesch, Ginsheim-Gustavsburg (DE); Bodo Kuhmann, Runkel (DE); Thorsten Kiehne, Shiga (JP); Franz Hora, Kriftel (DE)

Correspondence Address: PROPAT, L.L.C., 425-C SOUTH SHARON AMITY ROAD, CHARLOTTE, NC, 28211-2841, US

(21) Appl. No.: 11/629,939

(22) PCT Filed: Jun. 15, 2005
(86) PCT No.: PCT/EP05/06419

§ 371 Date: Dec. 18, 2006

(30) Foreign Application Priority Data
Jun. 24, 2004 (DE) 102004030455.6

(51) Int. Cl. B32B 7/02

(52) U.S. Cl. 428/220; 264/280

(57) ABSTRACT

The invention relates to a single-layer or multilayer, oriented film made of a thermoplastic polymer which contains at least one nanoparticulate metal oxide as an IR active component that is used for IR shielding, with the metal oxide being largely transparent in the visible range. Also disclosed are a method for producing the film and the use thereof as an insulating material, e.g. in window applications and as a shield for all sorts of electrical components. The invention further relates to a method for producing the raw material containing the nanoparticulate transparent metal oxide.

Film containing transparent metal oxide, method for the production thereof, and use thereof

The invention relates to a single- or multilayer, oriented film composed of a thermoplastic polymer which comprises at least one nanoparticulate metal oxide substantially transparent in the visible region as IR-active component which serves for IR shielding, to a process for production of the film, and to use of the film as insulation material, e.g. in window applications and as shielding for electrical components of any type. The invention further relates to a process for production of the polymer which comprises the nanoparticulate transparent metal oxide.

Polyester films for shielding from IR radiation (radiation whose wavelength is from more than 800 nm to about 1 mm) are of great economic interest for a number of reasons. Firstly, they can reduce the undesired heating of rooms and articles subject to IR irradiation (insolation or other natural, and also artificial, IR sources) and secondly they can also reduce heat loss via emitted IR radiation.

An example which may be mentioned is the window sector, where IR-protective films reduce undesired heating of rooms within buildings in summer, and in winter reduce heat loss via the window pane, thus in both cases contributing to the lowering of energy costs.

There are other applications in the sector of protective clothing in very hot or cold regions and for protection from heating in the case of electrical components during the “surface mounting” soldering procedure.

In industry, metals or metallized films are often used for IR shielding. However, this is possible only when there is no need, for example in the case of windows, for transparency in the visible region (from 400 to 800 nm). Other disadvantages of metallized products are inter alia, electrical conductivity, which in the case of electrical components can easily lead to short circuits or to other undesired contacts. Furthermore, low-cost aluminum-metallized products have only limited oxidation resistance, and the result is rapid loss of shielding action in particular in a moist environment or if acids and bases are present.

Another method of attenuating IR radiation is mixing to incorporate dyes which absorb and/or reflect in the IR region. There are disadvantages here either in the presence of color in the visible region, this mostly being quite marked and undesired, or in the low long-term light fastness of these dyes.

Transparent metal oxides, for example based on mixed tin oxides, such as indium tin oxide (ITO) or antimony tin oxide (ATO), can be useful here, having good IR-reflective or IR-absorptive action while at the same time exhibiting no, or very little, interaction with light in the visible wavelength region.

Coatings using these materials are known (JP 2000-188432 (TDK Corp./JP) and JP 2001-099924 (Sekisui Chem. Corp./JP)). Disadvantages of these coatings are, inter alia, the additional coating step needed and the thermal stress to which the layer is exposed. The latter point is of particular significance, since mixed tin oxides do not merely reflect IR radiation but also absorb it to a considerable extent. If the mixed tin oxide is then present in an externally applied layer, this experiences a larger temperature rise than the film situated thereunder or thereabove and the result is generally distortion in this layer and finally break-away of the layer.

It was an object of the present invention to provide a film which does not have the disadvantages mentioned of the prior art and which can be produced in a low-risk process.

This object is achieved via a single- or multilayer, at least monoaxially stretched thermoplastic polymer film with thickness of from 3 to 500 μm, preferably from 8 to 100 μm, and particularly preferably from 12 to 50 μm which comprises from 0.1 to 25.0% by weight, preferably from 0.5 to 10.0% by weight, and particularly preferably from 1.0 to 4.0% by weight, based on the film, of particles of at least one transparent metal oxide. The median particle size d₅₀ of these particles is ≦350 nm, preferably in the range from ≧7.0 to ≦150 nm, particularly preferably from ≧7.0 to ≦50 nm. This gives a film which has high transparency in the visible region and at the same time has low permeability in the IR region.

The transparent, nanoparticulate metal oxides are generally antimony tin oxide (ATO) and indium tin oxide (ITO), preferably indium tin oxide (ITO). However, it is also possible to use other transparent metal oxides, and also mixtures of ITO and/or ATO with these other transparent metal oxides, but preference is given here to mixtures of ITO and ATO. ATO or ITO/ATO mixtures can preferably be used when the price of the resultant film is more important than color neutrality.

The following formula gives the content of In₂O₃ and SnO₂ in the inventive ITO particles:
a In₂O₃+(100−a)SnO₂ formula 1
where a=from 20.0 to 99.7.
a is preferably ≧85.0 and particularly preferably ≧90.5.

It has proven advantageous here for the proportion of the transparent metal oxide (in percent by weight) as a function of film thickness to comply with the following equation:
G %=x*Ft^{(-0.9882)} formula 2
G %=proportion of transparent metal oxide in percent by weight.
Ft=film thickness in μm, where x (in % by weight/μm) is in the range from ≧10 to ≦250 and preferably from ≧40 to ≦100.

The film moreover has high transmittance in the visible wavelength region. In the preferred embodiment for window panes or motor vehicle windshields this is at least 65%, preferably ≧75%, and particularly preferably ≧80% at 650 nm. In contrast, transmittance at 2000 nm is ≦80%, preferably ≦60%, and particularly preferably ≦40%.

The value of the haze of the film is generally ≦5.0, preferably ≦2.0, and in one particular embodiment for “high performance” applications, such as front glazing of automobiles, preferably ≦1.5.

Since the film can undergo severe local heating via IR absorption, it has proven advantageous for there to be no film direction in which the shrinkage at 150° C. of the film is above 2.5%. The shrinkage is preferably below 1.5% in every film direction. It has moreover proven advantageous for the shrinkage difference between the longitudinal and transverse direction to be no greater than 1.0%.

Among the good mechanical properties are, inter alia, a modulus of elasticity in at least one film direction (longitudinal direction (MD) and/or transverse direction (TD)), or preferably in both film directions, of ≧500 N/mm², preferably ≧2000 N/mm², and particularly preferably ≧4000 N/mm².

The film of the invention comprises, as main polymer constituent (i.e. to an extent of from 55 to 100% by weight, preferably from 70 to 100% by weight, and particularly preferably from 90 to 100% by weight) a thermoplastic polymer, generally a polyester.

According to the invention, a thermoplastic polymer is
homopolyester,
copolymer,
a blend of various polyesters,
   and these can be used either in the form of pure polymers or else in the form of polymers comprising recycled material.

The thermoplastic polymer contains repeat units which derive from dicarboxylic acids (100 mol %) and from diols (likewise 100 mol %). The polyesters of the invention are preferably based on terephthalic acid or 2,6-naphthalenedicarboxylic acid as dicarboxylic acid and on ethylene glycol as diol. In a less preferred embodiment, the main diol component can also be 1,4-butanediol.

In particular the polyesters of the invention contain from 10 to 100 mol % of terephthalate or from 10 to 100 mol % of 2,6-naphthalate as dicarboxylic acid components (where the total amount of dicarboxylic acid components makes up 100 mol %). The polyester can contain, as further dicarboxylic acid components, from 0 to 50 mol % of 2,6-naphthalate (if terephthalate has been used as main component), from 0 to 50 mol % of terephthalate (if naphthalate has been used as main component), from 0 to 20 mol % of isophthalate (preferably from 0.5 to 4 mol %), or else from 10 to 60 mol % of 4,4′-diphenyldicarboxylate. It is advantageous if the proportion of other dicarboxylic acid components, such as 1,5-naphthalenedicarboxylate does not exceed 30 mol %, preferably 10 mol %, and particularly preferably 2 mol %.

The polyester of the invention contains, as diol component, from 10 to 100 mol % of ethylene glycol (EG) (where the total amount of diol components makes up 100 mol %). It is advantageous for the proportion of diethylene glycol not to exceed 10 mol %, and it is ideally from 0.5 to 5 mol %. The proportion of other diol components, such as cyclohexanedimethanol, 1,3-propanediol, 1,4-butanediol, should not exceed 50 mol % (with the exception of the less preferred variant using 1,4-butanediol as main diol component; i.e. from 50 to 100 mol %). Their proportion is preferably less than 30 mol %, particularly preferably less than 10 mol %.

Other embodiments of the film can comprise, alongside the main polymer constituents mentioned, up to 45% by weight, preferably up to 30% by weight, particularly preferably up to 20% by weight, based on the mass of the film, of other polymers, such as polyetherimides (e.g. Ultem® 1000 from GE Plastics Europe/NL), polycarbonate (e.g. Makrolon® from Bayer/DE) or polyamide (Ultramid® from BASF/DE), inter alia.

The polyesters are generally prepared from the abovementioned diols and dicarboxylic acid or dicarboxylic ester by processes known from the literature. The polyesters can be prepared either by the transesterification process using the conventional catalysts, e.g. the salts of Zn, of Ca, of Li, and of Mn, or by the direct esterification process. In order to achieve the inventively high transparency it is advantageous for the content of transesterification catalyst, based on the metal used, not to exceed 200 ppm. It is preferably less than 100 ppm, particularly preferably indeed less than 50 ppm. Preferred polycondensation catalysts are antimony compounds or germanium compounds. Titanium compounds are particularly preferred, however. If antimony compounds are used, in one preferred embodiment the content of antimony is less than 210 ppm and particularly preferably less than 70 ppm. It is preferable to use antimony triacetate (e.g. S21 antimony catalyst from Atofina, France).

It is particularly preferably to use titanium-based catalysts, such as VERTEC® AC420 from Johnson Matthey or C94 titanium catalyst from Acordis. The content of titanium here is preferably below 60 ppm and particularly preferably below 20 ppm. It has moreover proven advantageous for all the content of all of the components of the catalyst system, such as transesterification catalysts (e.g. manganese salts) and phosphorus-containing stabilizers (e.g. polyphosphoric acid, phosphorous acid, phosphoric esters, such as ethyl phosphate, diethyl phosphate, phenyl phosphate, inter alia) and polycondensation catalysts, such as titanium compounds not to exceed 200 ppm, preferably 100 ppm, and particularly preferably 75 ppm.

It has moreover proven advantageous to add stabilizers (free-radical scavengers) such as Irganox® 1010, 1425 or 1222 (Ciba, Switzerland) at concentrations of from 100 to 5000 ppm during the polycondensation process, since this markedly reduces formation of gel particles.

The polymers which comprise the transparent metal oxide are preferably prepared by one of the two following processes.

Process 1—Preparation of Polyesters (Masterbatches) by the Batch Process

A dispersion of the nanoscale metal oxides in ethylene glycol is added directly to the reactor during the polycondensation reaction. The addition can take place as early as the start of the polycondensation reaction (but in the case of the transesterification process always takes place after conclusion of the transesterification reaction), but preference is given to addition approximately halfway through the conventional polycondensation time, since this can minimize the content of discoloring by-products, but at the same time the viscosity of the polymer remains sufficiently low to ensure rapid dispersion of the nanoparticles in the polymer and thus to avoid undesired agglomeration. In order to avoid severe foaming of the reaction melt, the extent of reduced pressure used during the process can be reduced via introduction of dried nitrogen shortly prior to addition of the nanoparticle dispersion.

Process 2—Preparation of Masterbatches Comprising Nanoparticles Via Addition of the Nanoparticle Dispersion in a Twin-Screw Extruder

A dispersion of the nanoscale metal oxides in ethylene glycol or preferably in methyl ethyl ketone is input into the twin-screw extruder by way of a liquid feed. The preferred location of addition here is directly prior to or in the vent zone. High-content dispersions have to be used in this process, since otherwise an excessive amount of solvent has to be removed, and this means that the content of metal oxide is more than 10% by weight, preferably more than 20% by weight, and particularly preferably more than 25% by weight.

If twin-screw extruders are used in the film-production machinery, the dispersion can also be added directly to these extruders in a modification of process 2.

In both of the processes mentioned it has proven advantageous for the resultant polymer melt to be filtered, prior to pelletization, by way of melt filters whose pore size retains, according to the manufacturer, at least 50% of 7 μm particles and preferably at least 50% of 5 μm particles. Commercially available sintered filter materials are suitable, as also are nonwoven filters.

The form in which the ITO nanoparticles or ATO nanoparticles are used is preferably that of their dispersions in glycol. ITO dispersions from Nanogate (Saarbrücken) have proven particularly suitable (preferably those as used in the examples with more than 94% of indium oxide in the ITO).

The film of the invention is either a single- or multilayer film. The multilayer films are composed of a base layer B, of at least one outer layer A or C and, if appropriate, of other intermediate layers, particular preference being given to a three-layer A-B-A or A-B-C structure. For this embodiment it is advantageous for the melt viscosity of the polymer of the base layer B to be similar to that of the polymer(s) of the outer layer(s) adjoining the base layer.

The thickness of the outer layer(s) is selected independently from the other layers and is preferably in the range from 0.1 to 10.0 μm, in particular from 0.2 to 5.0 μm, preferably from 1.0 to 3.0 μm, and outer layers applied on the two sides can be identical or different with respect to thickness and constitution. The thickness of the base layer correspondingly is given by the difference between the total thickness of the film and the thickness of the outer and intermediate layer(s) applied and can therefore, similarly to the total thickness, vary within wide limits.

The transparent IR-absorbent metal oxides can be present in any of the layers of the film. In multilayer structures it has proven advantageous for at least two successive layers to comprise these particles. It is particularly advantageous for all of the layers to comprise at least 5% of the amount of these particles, based on the amount in % of metal oxide in the layer with the highest amount of particles, since this reduces large differences in temperature rises of the layers which can otherwise lead to delamination problems.

In window applications, in which a powerful source of heat (e.g. the sun) irradiates one side, it has proven advantageous for the layer of the film facing toward the light source to comprise an amount of transparent IR-absorbent metal oxide which is less by 10%, preferably by at least 20%, than the adjacent layer. In films with more than two layers, these differences apply to each layer.

A particular case as preferred embodiment is lamination using PVB (polyvinyl butyral) films. In this case it is advantageous for the layer(s) in contact with the PVB to comprise at most 10% of the amount of IR-absorbent metal oxides, based on the amount in % of metal oxide in the layer with the largest amount of particles.

The inventive film can comprise, in one or more layers, other particulate additives alongside the transparent metal oxides, e.g. fillers and antiblocking agents. Typical fillers and antiblocking agents are inorganic and/or organic particles, such as silicon dioxide (natural, precipitated, or fumed), calcium carbonate, magnesium carbonate, barium carbonate, calcium sulfate, barium sulfate, lithium phosphate, calcium phosphate, magnesium phosphate, titanium dioxide (rutile or anatase), kaolin (hydrated or calcined), aluminum oxide, aluminum silicates, lithium fluoride, the calcium, barium, zinc, or manganese salts of the dicarboxylic acids used, or crosslinked polymer particles, e.g. polystyrene or polymethyl methacrylate particles.

It is also possible to select mixtures of two or more of the abovementioned particle systems or mixtures of particle systems whose chemical constitution is the same but whose particle size differs. It is advantageous to add the particles to the polyester prior to the start of melting.

If other particulate additives are present in a layer of the film, the total concentration of these particles is generally less than 10% by weight, based on the total mass of the respective layer, preferably less than 5% by weight and particularly preferably less than 1% by weight. The median size (d₅₀ value) of the particulate additives is from 0.01 to 3.5 μm, preferably from 0.03 to 3.0 μm, and particularly preferably from 0.05 to 2.8 μm. In one preferred embodiment, the proportion of particles whose d₅₀ value is ≧3 μm is ≦500 ppm, preferably ≦300 ppm, and particularly preferably ≦100 ppm.

In one preferred embodiment, the film comprises from 0.1 to 2.0% by weight, and preferably from 0.15 to 1.0% by weight, of silicon dioxide particles whose d₅₀ is ≦1 μm and from 0 to 500 ppm of silicon dioxide particles whose d₅₀ is ≧1 μm and ≦3 μm. These particles are preferably added to one or both external layers. The median diameter d₅₀ of these particles is measured by conventional methods.

Since the films of the invention can undergo a local rise in temperature as a consequence of their IR absorption, they are more susceptible to hydrolytic degradation than polyester films without transparent IR-absorbent metal oxides; it can be advisable to make additional use of a hydrolysis stabilizer. Examples of suitable hydrolysis stabilizers are polymeric carbodiimides, such as Stabaxol® P from Rhein Chemie, Germany. The amount of these used is preferably from 0.1 to 1.0% by weight, based on the weight of the film.

In another preferred embodiment, the transparent film comprises at least one UV stabilizer as light stabilizer, advantageously fed directly by way of what is known as masterbatch technology directly during film production, the concentration of UV stabilizer here preferably being from 0.01 to 5.0% by weight, based on the weight of the layer of the crystallizable thermoplastic.

UV stabilizers suitable as light stabilizers are UV stabilizers which absorb at least 70%, preferably 80%, particularly preferably 90%, of the UV light in the wavelength range from 180 to 380 nm, preferably from 280 to 350 nm. These are particularly suitable if they are thermally stable in the temperature range from 260 to 300° C., i.e. do not decompose and do not cause evolution of gases. Examples of UV stabilizers suitable as light stabilizers are 2-hydroxybenzophenones, 2-hydroxybenzotriazoles, organonickel compounds, salicylic esters, cinnamic ester derivatives, resorcinol monobenzoates, oxanilides, hydroxybenzoic esters, and sterically hindered amines and triazines, preference being given to the 2-hydroxybenzotriazoles and the triazines.

In one particularly preferred embodiment, the transparent film comprises from 0.01 to 5% by weight of 2-(4,6-diphenyl-1,3,5-triazin-2-yl)-5-(hexyl)oxy-phenol, or from 0.01 to 5% by weight of 2,2′-methylenebis(6-(2H-benzotriazol-2-yl)-4-(1,1,3,3-tetramethylbutyl)phenol.

In another preferred embodiment, it is also possible to use a mixture of these two UV stabilizers or a mixture of at least one of these two UV stabilizers with other UV stabilizers, the total concentration of light stabilizer here generally being in the range from 0.01 to 5% by weight, based on the weight of polymer. Tinuvin® light stabilizers from Ciba have proven particularly suitable. In one preferred UV-stabilized embodiment, transmittance at 390 nm is below 70% and preferably below 60%. Transmittance at 360 nm is below 50% and preferably below 25%.

It has moreover proven advantageous for the film to comprise an optical brightener in addition to the UV stabilizer. A particularly suitable product for this purpose is OB-One from Ciba. In a multilayer structure it has moreover proven advantageous for the location of the optical brightener to be in that layer of the film which faces toward the light source.

The film can likewise be coated in order to establish other properties. Particularly typical coatings are layers with adhesion-promoting, antistatic, slip-improving, or release action. Clearly, these additional layers can be applied to the film by way of in-line coating by means of aqueous dispersions after longitudinal stretching and prior to transverse stretching.

In one particular embodiment, at least one side of the film has a silicone coating as described by way of example in U.S. Pat. No. 5,728,339. An advantage of this embodiment is that this film surface is easier to clean, this being necessary by way of example if this layer of the film can be subject to external contact.

Since, in one preferred embodiment, the film is laminated using a PVB film, it has proven advantageous for one or both sides of the film to be coated with an aqueous solution/dispersion of a hydrolyzed aminosilane compound. The coating is preferably applied in-line, i.e. during the film production process, advantageously prior to transverse stretching. Particular preference is given to application of the coating by means of the reverse gravure roll process, which can apply the coating extremely homogeneously. Preference is likewise given to application of the coating by the Meyer Rod process, which can achieve relatively large coating thicknesses. The coating takes the form of a diluted aqueous solution/dispersion when applied to the film and then the solvent/dispersion medium is evaporated. If the coating is applied in-line prior to transverse stretching, the heat treatment in transverse stretching is usually sufficient to evaporate the solvent/dispersion medium and dry the coating.

Suitable aminosilane compounds have, in the unhydrolyzed state, the general formula
(R¹)ₐSi(R²)_{b}(R³)_{c}
where R¹ is a functional group having at least one primary amino group, R² is a hydrolyzable group selected from the group consisting of an alkoxy group having from 1 to 8 carbon atoms, an acetoxy group, and a halide group, and R³ is an unreactive, non-hydrolyzable group selected from the group consisting of a low alkyl group having from 1 to 8 carbon atoms and a phenyl group. The coefficient a is ≧1, the coefficient b is likewise ≧1, and the coefficient c is ≧0, and a+b+c=4.

N-(2-Aminoethyl)-3-aminopropyltrimethoxysilane of the formula 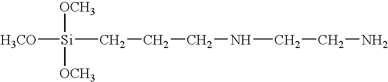
is preferred as aminosilane compound. This compound is supplied commercially by Dow Corning (DE) with the name Z-6020.

The coating described above has been described in detail in EP-B-0 359 017, which is expressly incorporated herein by way of reference (cf. in particular pp. 3-5). That specification also describes other suitable aminosilane compounds which, although they are not given here, are expressly encompassed by the present invention.

It has been found that a film coated with the dried residue of a hydrolyzed aminosaline compound in an amount from 0.5 to 100 mg/m², preferably from 2 to 50 mg/m², and particularly preferably from 10 to 25 mg/m², has markedly improved adhesion between the PET film and the PVB.

All of the additives, such as the further fillers present if appropriate and the other additives, can be introduced into the polymer by means of a commercially available twin-screw extruder (e.g. from Coperion), with the exception of the transparent IR-active metal oxides, whose introduction has been previously described above. In this process, inventive polyester pellets together with the particles/additives are introduced into the extruder and extruded, and the material is then quenched in a waterbath and then pelletized.

In a preferred process for preparation of the inventive thermoplastics, however, the additives are added directly during polymer preparation. In the case of the DMT process, the additives are usually added in the form of a glycolic dispersion after the transesterification reaction or directly prior to the polycondensation reaction, e.g. by way of the transport line between transesterification vessel and polycondensation vessel. However, the addition can also take place directly prior to the transesterification reaction. In the case of the TPA process, the addition preferably takes place at the start of the polycondensation reaction. However, subsequent addition is also possible. In this process it has proven advantageous for the glycolic dispersions to be filtered by way of a PROGAF® PGF 57 (Hayward Ind., USA) filter, prior to addition.

The present invention also provides a process for production of the film. The production method generally uses an extrusion process, e.g. on an extrusion line. It has proven particularly advantageous to add the additives in the form of predried or precrystallized masterbatches, prior to extrusion.

In masterbatch technology it is preferable that the particle size and the bulk density of the masterbatches are similar to the particle size and the bulk density of the polymer used, thus achieving homogeneous dispersion, resulting in homogeneous properties.

The films may be produced in the form of a single- or multilayer film by known processes from a polymer and, if appropriate, from further raw materials, from at least one polymer (masterbatch) using transparent IR-active metal oxide, and also, if appropriate, from further additives.

The raw materials are preferably predried. The predrying includes progressive heating of the masterbatches under reduced pressure (from 20 to 80 mbar, preferably from 30 to 60 mbar, in particular from 40 to 50 mbar), with stirring, and, if appropriate, post-drying at a constant elevated temperature (likewise under reduced pressure). It is preferable for the masterbatches to be charged batchwise at room temperature from a feed vessel in the desired blend together with the polymer and, if appropriate, with other raw material components into a vacuum dryer in which the temperature profile moves from 10 to 160° C., preferably from 20 to 150° C., in particular from 30 to 130° C., during the course of the drying time or residence time. During the residence time of about 6 hours, preferably 5 hours, in particular 4 hours, the raw material mixture is stirred at from 10 to 70 rpm, preferably from 15 to 65 rpm, in particular from 20 to 60 rpm. The resultant precrystallized or predried raw material mixture is post-dried in a downstream vessel, likewise evacuated, at temperatures of from 90 to 180° C., preferably from 100 to 170° C., in particular from 110 to 160° C., for from 2 to 8 hours, preferably from 3 to 7 hours, in particular from 4 to 6 hours.

However, the masterbatches, and also the other raw materials, can also be directly extruded without predrying if twin- and multiscrew extruders are used.

In the preferred extrusion or coextrusion process for production of the film, the melts corresponding to the individual layers of the film are extruded or coextruded through a flat-film die and are quenched in the form of a substantially amorphous prefilm on a chill roll. In the case of the inventive single-layer film, only one melt is extruded through the die. It has proven advantageous for the polymer melt(s) to be filtered, prior to entry into the die, by way of melt filters whose pore size retains, according to the manufacturer, at least 50% of 7 μm particles and preferably at least 50% of 5 μm particles. Commercially available sintered filter materials are suitable, as also are nonwoven filters.

This film is then reheated, and oriented longitudinally and transversely, or transversely and longitudinally, or longitudinally, transversely, and again longitudinally and/or transversely. The film temperatures in the stretching process are generally above the glass transition temperature T_{g} of the polyester used by from 10 to 60° C., and the longitudinal stretching ratio is usually from 2 to 6, in particular from 3 to 4.5, the transverse stretching ratio usually being from 2 to 5, in particular from 3 to 4.5, the ratio for any second longitudinal and transverse stretching carried out usually being from 1.1 to 5. The first longitudinal stretching may also be carried out simultaneously with the transverse stretching (simultaneous stretching). The heat-setting of the film follows at oven temperatures of from 180 to 260° C., in particular from 220 to 250° C. The film is then cooled and wound.

In one preferred embodiment, the heat-setting takes place at from 220 to 250° C., and the film is relaxed transversely at this temperature by at least 1%, preferably at least 2%, particularly preferably at least 4%.

In another preferred embodiment, the heat-setting takes place at from 220 to 250° C. and the film is transversely relaxed at this temperature by at least 1%, preferably at least 2%, and is then again in turn transversely relaxed by at least 1%, preferably at least 2%, at temperatures at from 180 to 150° C. during the cooling phase.

In another embodiment, the film is stretched by at least a factor of 3 in MD and TD, and this stretching takes place in a simultaneous frame. The heat-setting takes place at from 220 to 250° C., and the film at this temperature is transversely relaxed by at least 2.0% and preferably also longitudinally by from 0.5 to 5.0%.

Particularly in the case of use of IR sources for heating of the film prior to and during the width stretching and heat-setting, overheating of the film can occur by virtue of the IR absorption of the metal oxides used. This is mostly apparent through sagging or exaggerated flapping of the film web, with consequent break-offs. In these cases the intensity of the sources or the temperature of the respective zones in the stretching frame or setting frame has to be reduced until the film regains tension in the frame.

A particular point requiring attention is that the velocity differences between successive rolls outside the stretching regions is minimized, thus avoiding slip of the film over the roll and scratching.

The inventive single- or multilayer films have the good mechanical properties demanded. Thus, the modulus of the elasticity in at least one film direction (longitudinal (MD) and/or transverse (TD)) is at least 500 N/mm², preferably at least 2000 N/mm², and particularly preferably at least 4000 N/mm².

In one preferred application, the film, which by this stage preferably has, as described above, an in-line-applied aminosilane coating, is again given an aminosilane coating on this side off-line and is subjected to lamination using PVB on this side. The other side is provided with a “hard coat” known from the literature, and the PVB side is laminated to glass. EP A-0319911 describes by way of example the individual steps for production of this type of composite.

In another preferred application, one side of the film is coated using a conventional industrial adhesive with adhesion to glass, generally based on silane coupling agents. A siliconized polyester film is applied as release liner to the adhesive coating. The other side of the film has preferably been provided with a “hard coat” known from the literature, but can also be uncoated or have another type of coating, or can have been laminated using further film sublayers.

The film of the invention is used as insulating material, e.g. in window applications and as shielding for electrical components of any type.

The individual properties of the films were measured using the standards and methods stated below.

Methods

Mechanical Properties

Modulus of elasticity, ultimate tensile strength, tensile strain at break, and F₅ value are measured longitudinally and transversely to ISO 527-1-2 with the aid of a tensile strain tester (Zwick, 010, Ulm, Germany).

Transmittance

Transmittance is measured using a Lambda® 9 spectrometer from Perkin Elmer, USA. The measurement speed is 120 nm per minute from 2500 to 320 nm using transmitted light.

Shrinkage

Thermal shrinkage was determined on square samples of film with edge length 10 cm. The specimens are measured precisely before the test (edge length L₀) and heat-conditioned for 15 minutes at 150° C. in a cabinet with air circulation. The specimens are removed and likewise measured precisely at room temperature (edge length L). Shrinkage is calculated from the following equation:
Shrinkage [%]=100*(L₀−L)/L₀
Production, Shape, and Number of Specimens

Five specimens (for measurements in MD and TD) of size 100×100 mm are cut out from each of the films to be studied. The longitudinal and transverse direction are marked on the margin, since tests take place in both machine directions.

Testing of Haze

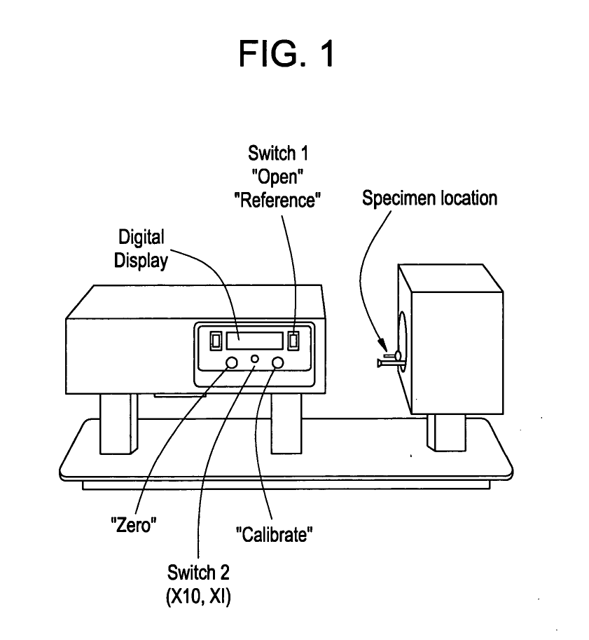

A Hazegard Hazemeter®XL-211 from BYK Gardner (see FIG. 1) is used for the test. The test equipment is to be switched on 30 minutes to the prior test. Care is to be taken that the light beam passes through the sphere centrally to the outgoing aperture.

Testing of Haze (see FIG. 1)

Press switch 1 “OPEN”

Set switch 2 to “X10” and calibrate digital display to 0.00, using the “Zero” knob

Move switch 1 to “Reference” and switch 2 to “X1”

Bring the digital display to 100, using the “Calibrate” knob

Insert specimen longitudinally

Read off displayed transparency value

Calibrate the digital display to 100, using the “Calibrate” knob

Set switch 1 to “OPEN”

Read off displayed value for longitudinal haze

Rotate specimen to transverse direction

Read off displayed value for transverse haze

Evaluation

Haze is obtained by averaging the respective 5 individual values (longitudinally and transversely).

Film Production

Polyester chips were mixed in the ratios stated in the examples and in each case without predrying melted in an extruder, in the case of monofilm in a single-screw extruder and in the case of coextruded film in each case in twin-screw extruders. The molten polymer strand(s) was/were extruded through a die (in the case of coextrusion, the polymer strands were combined in a coextrusion die) and drawn off by way of a take-off roll (roll temperature 20° C.). The film was stretched by a factor of 3.5 in the machine direction at 116° C. (film temperature in stretching gap) and transverse stretching by a factor of 3.6 was carried out in a frame at 110° C. The film was then heat-set at 236° C. and transversely relaxed by 3.0% at temperatures of from 236 to 200° C. and again by 1.0% at temperatures of from 180 to 150° C. The production speed (final film speed) is 250 m/min.

### EXAMPLES

The following raw materials are used in the examples.

R1

Masterbatch with 4% by Weight of ITO (Nano-ITO from Nanogate, Saarbrücken) in PET

Preparation: ethylene glycol and dimethyl terephthalate were transesterified using 40 ppm of manganese acetate as transesterification catalyst. After conclusion of the tranesterification reaction, the temperature was raised to 240° C. and once this temperature had been reached phosphorous acid (15 ppm of phosphorus) was added as stabilizer. The reaction mixture was then transferred by pumping into the polycondensation vessel. 15 ppm of titanium from C94 titanium catalyst from Acordis were used as polycondensation catalyst. A dispersion of 20% of nano-ITO in glycol (primary particle size from 10 to 20 nm, 95In₂O₃+5SnO₂) from Nanogate was passed into the polycondensation vessel 15 minutes after the pumped transfer of the transesterification mixture. The vacuum was broken via addition of dry nitrogen and the vessel was then again evacuated.

R2

Masterbatch with 2% by Weight of ITO (Nano-ITO from Nanogate, Saarbrücken) and 2% of ATO (Advanced Nano Products Co., Ltd., Korea) in PET

Preparation: ethylene glycol and dimethyl terephthalate were transesterified using 40 ppm of manganese acetate as transesterification catalyst. After conclusion of the tranesterification reaction, the temperature was raised to 240° C. and once this temperature had been reached phosphorous acid (15 ppm of phosphorus) was added as stabilizer. A dispersion of 20% by weight of nano-ITO in glycol (primary particle size from 10 to 20 nm, 95In₂O₃+5SnO₂) from Nanogate and a dispersion of 20% by weight of ATO in glycol (80% of particles being smaller than 100 nm) was passed into the polycondensation vessel directly after the pumped transfer of the transesterification mixture. 10 ppm of titanium from C94 titanium catalyst were used as polycondensation catalyst.

R3

Masterbatch with 3% by Weight of ITO (Nano-ITO from Nanogate, Saarbrücken) in PEN

Preparation: ethylene glycol and dimethyl naphthalate were transesterified using 30 ppm of manganese acetate as transesterification catalyst. After conclusion of the tranesterification reaction, the temperature was raised to 240° C. and once this temperature had been reached phosphorous acid (11 ppm of phosphorus) was added as stabilizer. The reaction mixture was then transferred by pumping into the polycondensation vessel. 15 ppm of titanium from C94 titanium catalyst were used as polycondensation catalyst. A dispersion of 20% of nano-ITO in glycol (primary particle size from 10 to 20 nm, 95In₂O₃+5SnO₂) from Nanogate was passed into the polycondensation vessel directly after the pumped transfer of the transesterification mixture.

R4

Masterbatch with 4% by Weight of ITO (Nano-ITO from Nanogate, Saarbrücken) in PET

Preparation: ethylene glycol and dimethyl terephthalate were transesterified using 40 ppm of manganese acetate as transesterification catalyst. After conclusion of the tranesterification reaction, the temperature is raised to 240° C. and once this temperature had been reached phosphorous acid (15 ppm of phosphorus) is added as stabilizer. A dispersion of 20% by weight of nano-ITO in glycol (primary particle size from 10 to 20 nm, 95In₂O₃+5SnO₂) from Nanogate was passed into the polycondensation vessel directly after the pumped transfer of the transesterification mixture. 10 ppm of titanium from C94 titanium catalyst were used as polycondensation catalyst.

R5

MB4 Comprises 20% by Weight of 2-(4,6-diphenyl-1,3,5-triazin-2-yl)-5-hexyloxyphenol (Tinuvin 1577) (Ciba Geigy, Switzerland) UV stabilizer.

Preparation: the UV stabilizer was added after polyester preparation to a polyester (catalyst/stabilizer system are 20 ppm of Ti from C94 titanium catalyst, 50 ppm of Mn from Mn(Ac)₂ and 20 ppm of P from phosphoric acid) in a twin-screw extruder.

R6

Hydrolysis Stabilizer: P100 Masterbatch from Rhein Chemie, Germany

R7

100% by Weight of RT49 Polyethylene Terephthalate from Cosa, Germany

R8

100% by Weight of P100 Polyethylene Naphthalate from Cosa, Germany

### EXAMPLES

Monofilms and three-layer films were produced as described in the introduction. Raw material constitution of the films and their properties can be found in the table.

TABLE

| | | | | | | | | | | ITO | Proportion | Proportion | Thickness | Total | | X from |
|---|---|---|---|---|---|---|---|---|---|---|---|---|---|---|---|---|
| | Example | R1 | R2 | R3 | R4 | R5 | R6 | R7 | R8 | in % | of PET | of PEN | (layer) | thickness | Haze in % | formula 2 |
| | 1 | 75 | | | | 15 | | 10 | | 3 | 100 | 0 | 20 | 20 | 0.5 | 57.9 |
| | 2 | | | | 50 | 10 | | 40 | | 2 | 100 | 0 | 50 | 50 | 0.9 | 95.5 |
| | 3 | | 80 | | | 10 | 10 | | | 1.6 | 100 | 0 | 50 | 50 | 1.9 | 76.4 |
| | 4 | | 25 | | | 5 | | 70 | | 0.5 | 100 | 0 | 250 | 250 | 2.4 | 117.1 |
| | 5 | | | 25 | | | | | 75 | 0.75 | 0 | 100 | 125 | 125 | 1 | 88.6 |
| | CE 1 | | | | | | | 100 | | 0 | 100 | 0 | 50 | 50 | 0.8 | n.a |
| | CE 2 | | | | | | | | 100 | 0 | 0 | 100 | 50 | 50 | 0.7 | n.a. |
| Example | Layer | | | | | | | | | | | | | | | |
| 6 | A | 10 | | | | 30 | | 60 | | 0.4 | 100 | 0 | 4 | 50 | 1.4 | 63.88 |
| | B | 35 | | | | 10 | | 55 | | 1.4 | 100 | 0 | 42 | | | |
| | C | 40 | | | | 5 | | 55 | | 1.6 | 100 | 0 | 4 | | | |
| 7 | A | 50 | | | | 30 | | 20 | | 2 | 100 | 0 | 4 | 50 | 1.4 | 95.5 |
| | B | 50 | | | | 10 | | 40 | | 2 | 100 | 0 | 42 | | | |
| | C | 50 | | | | 5 | | 45 | | 2 | 100 | 0 | 4 | | | |

| | | | | | Transparency | Transverse | Longitudinal | Transverse |
|---|---|---|---|---|---|---|---|---|
| | | Transparency | Transparency | Transparency | at | modulus of | shrinkage | shrinkage |
| | Example | at 360 nm | at 390 nm | at 650 nm | 2000 nm | elasticity | at 150° C. | at 150° C. |
| | 1 | 0.9 | 50 | 92 | 38 | 4300 | 1 | 0.5 |
| | 2 | 0.9 | 30 | 91 | 28 | 4700 | 0.9 | 0.6 |
| | 3 | 0.8 | 30 | 85 | 31 | 4500 | 1.2 | 0.5 |
| | 4 | 0.6 | 33 | 87 | 9 | 4100 | 0.8 | 0.4 |
| | 5 | 2.4 | 85 | 89 | 31 | 4300 | 0.9 | 0.4 |
| | CE 1 | 92 | 92 | 93 | 93 | 4200 | 0.9 | 0.5 |
| | CE 2 | 2.5 | 80 | 94 | 95 | 4300 | 1.1 | 0.6 |
| Example | Layer | | | | | | | |
| 6 | A | 0.9 | 31 | 88 | 33 | 4600 | 1 | 0.4 |
| | B | | | | | | | |
| | C | | | | | | | |
| 7 | A | 1.5 | 32 | 89 | 27 | 4450 | 1 | 0.5 |
| | B | | | | | | | |
| | C | | | | | | | |

n.a. = not applicable
CE = comparative example

1. A single- or multilayer, at least monoaxially stretched thermoplastic polymer film with thickness of from about 3 to 500 μm, comprising from about 0.1 to 25.0% by weight, based on the film, of particles of at least one transparent metal oxide, wherein the median particle size d₅₀ of these particles is less than or equal to about 350 nm.

2. The film as claimed in claim 1, which comprises from about 0.5 to 10.0% by weight of transparent metal oxide particles.

3. The film as claimed in claim 1, wherein the median particle size d₅₀ of the transparent metal oxide particles is in the range from greater than or equal to about 7.0 to less than or equal to 150 nm.

4. The film as claimed in claim 1, wherein said film has a thickness of from about 8 to 100 μm.

5. The film as claimed in claim 1, wherein the proportion of the transparent metal oxide in percent by weight as a function of film thickness complies with the equation
G %=x*Ft^{(-0.9882)}
where G %=proportion of transparent metal oxide in percent by weight and Ft=film thickness in μm, where x in % by weight/μm is in the range from greater than or equal to about 10 to less than or equal to 250.

6. The film as claimed in claim 1, which has a transmittance of at least about 65% at 650 nm and of less than or equal to about 80% at 2000 nm.

7. The film as claimed in claim 1, wherein said transparent, metal oxides comprises antimony tin oxide, indium tin oxide, and other transparent metal oxides, alone or in mixtures.

8. The film as claimed in claim 1, wherein shrinkage of said film at 150° C. is not above about 2.5% in any direction on the film.

9. The film as claimed in claim 1, wherein the thermoplastic polymer is a homopolyester or copolyester or a blend of various polyesters.

10. The film as claimed in claim 1, wherein the film is a multilayer film and the multilayer film comprises a base layer B, at least one outer layer A or C, and, optionally other intermediate layers.

11. The film as claimed in claim 1, wherein the thickness of the outer layer(s) is/are in the range from about 0.1 to 10.0 μm.

12. The film as claimed in claim 1, wherein said film comprises other particulate additives and at least one UV stabilizer.

13. The film as claimed in claim 1, wherein said film has been coated.

14. The film as claimed in claim 1, wherein said film further comprises recycled material.

15. A process for production of a film as claimed in claim 1, which comprises, in an extrusion or coextrusion process, extruding or coextruding the melts corresponding to the individual layers of the film through a flat-film die and quenching them in the form of substantially amorphous prefilm on a chill roll, and then reheating the film and orienting it longitudinally and transversely, or transversely and longitudinally, or longitudinally, transversely, and again longitudinally and/or transversely, and then heat-setting the film at temperatures of from 180 to 260° C., cooling it, and winding it up.

16. Insulating material in window applications and as or screening for electrical components comprising film as claimed in claim 1.

17. The film as claimed in claim 1, which comprises from about 1.0 to 4.0% by weight of transparent metal oxide particles.

18. The film as claimed in claim 1, wherein said film has a thickness of from about 12 to 50 μm.

19. The film as claimed in claim 1, wherein X is in the range from about greater than or equal to 40 to less than or equal to 100.

20. The film as claimed in claim 7, wherein said transparent metal oxide comprises one or more of antimony tin oxide or indium tin oxide.

21. The film as claimed in claim 8, wherein the shrinkage is below about 1.55 in every direction on the film.

22. The film as claimed in claim 10, wherein the film comprises a three-layer A-B-A or A-B-C structure.

23. The film as claimed in claim 11, wherein the thickness of the outer layer(s) ranges from about 0.2 to 5.0 μm.

24. The film as claimed in claim 11, wherein the thickness of the outer layer(s) ranges from about 1.0 to 3.0 μm.

25. The film as claimed in claim 12, wherein the particulate additives are fillers and antiblocking agents.
